(19) United States
(12) Patent Application Publication
(10) Pub. No.: US 2017/0129628 A1
(43) Pub. Date: May 11, 2017

(54) Thermal-nucleak powered rocket using non-cryogenic propellant

(71) Applicant: IGOR JOHN EBERSTEIN, CHEVY CHASE, MD (US)

(72) Inventor: IGOR JOHN EBERSTEIN, CHEVY CHASE, MD (US)

(21) Appl. No.: 15/330,757

(22) Filed: Nov. 3, 2016

Related U.S. Application Data
(60) Provisional application No. 62/285,762, filed on Nov. 6, 2015.

(51) Int. Cl. B64G 1/40; F02K 9/42

(52) U.S. Cl. CPC B64G 1/408; F02K 9/425; F05D 2220/80

(57) ABSTRACT

The invention comprises a space ship, which commutes between earth orbit and lunar orbit, and is powered by a rocket engine, using superheated steam, or other non-cryogenic propellant, where the propellant is heated in a conventional uranium nuclear reactor.

### PRIORITY

This application claims the benefit of U.S. Provisional Application No. 62/285,762 filed on Nov. 6, 2015.

No government resources were used in the conception or development of this invention.

### BACKGROUND

Chemical rockets have reached the limit of their usefulness for the exploration of the solar system. This is especially true for interplanetary manned flight. Saturn class rockets are too large, too complicated and too dangerous. The present invention overcomes the above problems by using a simple system with proven technology.

The present innovation uses a standard nuclear power reactor design: A minimally enriched, or even natural, uranium fueled core turns liquid water into super-heated steam, which powers a rocket engine. Nuclear powered rocket engines have been proposed for many years, and many have been tested. However, the designs have generally been aimed at obtaining maximum specific impulse, using hydrogen as propellant. The technical problems have been immense, especially for graphite core reactors using hydrogen as propellant.

### OBJECTIVE

The objective of the present invention is to develop a simple and reliable propulsion system for a space ship which commutes between earth orbit and lunar orbit. It is essential that maintenance and complexity be kept to a bare minimum. The design may also be used to power a shuttle, which goes between the lunar orbiter and the lunar surface.

### INVENTION

The innovation comprises a rocket engine using superheated steam, or other non-cryogenic propellant, where the propellant is heated by a conventional uranium nuclear reactor. Enrichment is to be kept to a minimum, so as to facilitate international use and cooperation. The propellant will be superheated to very high temperatures, such temperatures being only limited by the materials used. Suggested materials are: titanium, suitable titanium alloys, or suitable high temperature ceramics. Water from a storage tank is first vaporized in a pre-reactor, which may be either a nuclear reactor or an appropriate heat exchanger, depending on design requirements. The high-pressure steam is then passed to the main reactor for additional heating to the maximum temperature permitted by the material of the core. Finally, the superheated steam is passed through a rocket nozzle to generate thrust for the propulsion. The system comprises the following:
1.) A fuel tank containing liquid water or other non-cryogenic propellant.
2.) A pump connected to said fuel tank.
3.) A vaporizer connected to said fuel tank
4.). A final heating core connected to said vaporizer.
5.) A rocket chamber and nozzle connected to said final heating core.

Unique and Novel Features of the Innovation and the Benefits of its Application:

The non-obvious feature of this innovation is to use superheated steam as the propellant. It is analogous to the battery that ran on tap water. Nobody had thought of it. It is safe, simple and reusable. The simplifications attained by not having to use cryogenics are substantial.

Furthermore, water is a natural element of the various bodies of the solar system, and is thus not a pollutant.

Potential Commercial Applications:

The above invention may be used to help support a permanent lunar base, and to support mining operations on the moon. In this respect, the mining of Thorium and Uranium are especially attractive, as these may be used as fuel for the space ship. The mining of Helium3 is also attractive, as it may be used for nuclear fusion projects.

1: A space ship, which commutes between earth orbit and lunar orbit, and is powered by a rocket engine using superheated steam, or other non-cryogenic propellant, where the propellant is heated in a conventional uranium nuclear reactor.

2: A rocket engine using superheated steam, or other suitable non-cryogenic propellant, where the propellant is heated by a conventional nuclear core.
